(19) United States
(12) Patent Application Publication
(10) Pub. No.: US 2007/0129013 A1
(43) Pub. Date: Jun. 7, 2007

(54) Apparatus and methods for information handling system with streamlined communication setup

(76) Inventors: Pratik M. Mehta, Austin, TX (US); Alan E. Sicher, Austin, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/294,988

(22) Filed: Dec. 6, 2005

(51) Int. Cl. H04B 7/00; H04M 3/00

(52) U.S. Cl. 455/41.2; 455/418

(57) ABSTRACT

An information handling system includes a wireless subsystem. The wireless subsystem is configured to establish communication with a desired wireless device. The wireless subsystem uses pre-configured information about the wireless device in order to establish communication with the wireless device without an end user providing the information about the wireless device.

### TECHNICAL FIELD

The inventive concepts relate generally to information handling apparatus and systems. More particularly, the invention concerns apparatus and associated methods for setting up devices with a wireless link, such as Bluetooth compliant devices, and providing connectivity to such devices.

### BACKGROUND

As the value and use of information continues to increase, individuals and businesses seek additional ways to process and store information. One option available to users is information handling systems or apparatus. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated.

The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As the complexity and functionality of information handling systems and apparatus has grown, the processing of information has tended to become more distributed or networked, resulting a desire for increased communication flexibility. Wireless devices provide a cable-free solution that provides increased communication flexibility. One type of wireless device, Bluetooth, has gained popularity with users for providing connectivity among peripherals and similar equipment. Unfortunately, conventional techniques for setting up and providing such connectivity tend to be complex and confusing for the user.

### SUMMARY

The disclosed novel concepts relate to apparatus and associated methods for setting up devices with a wireless link and providing connectivity to such devices. An example of a kind of such devices constitutes Bluetooth devices, which persons of ordinary skill in the art know.

In one embodiment, an information handling system includes a wireless subsystem. The wireless subsystem is configured to establish communication with a desired wireless device. The wireless subsystem uses pre-configured information about the wireless device in order to establish communication with the wireless device without an end user providing the information about the wireless device.

In another embodiment, a computer system includes an information handling apparatus. The information handling apparatus includes a Bluetooth device and a Bluetooth subsystem. The Bluetooth subsystem is configured to communicate with the Bluetooth device. The Bluetooth subsystem communicates with the Bluetooth device by using pre-configured information about the Bluetooth device stored within the information handling apparatus.

In yet another embodiment, a method of communicating with a Bluetooth device includes obtaining the name of the Bluetooth device, and requesting a user to cause the Bluetooth device to transmit information about the Bluetooth device. The method further includes using pre-configured information about the Bluetooth device and information transmitted by the Bluetooth device to establish communication with the Bluetooth device without obtaining information about the Bluetooth device from the user.

### BRIEF DESCRIPTION OF THE DRAWINGS

The appended drawings illustrate only exemplary embodiments of the invention and therefore should not be considered or construed as limiting its scope. Persons of ordinary skill in the art who have the benefit of the description of the invention appreciate that the disclosed inventive concepts lend themselves to other equally effective embodiments. In the drawings, the same numeral designators used in more than one drawing denote the same, similar, or equivalent functionality, components, or blocks.

FIG. 1 shows a simplified block diagram of an information handling system that includes wireless devices and functionality.

FIG. 2 illustrates a conventional method of setting up Bluetooth devices.

FIG. 3 depicts a simplified block diagram of a method for communicating with, and setting up, Bluetooth devices.

FIGS. 4A-4C show an exemplary graphical user interface (GUI) for setting up, and communicating with, a Bluetooth mouse (as an example among other possibilities).

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes.

For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory.

Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

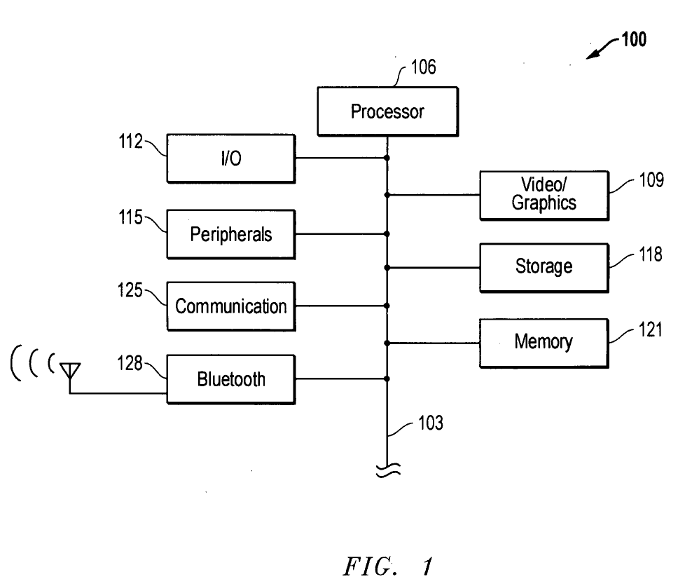

FIG. 1 shows a simplified block diagram of an information handling system 100 according to an exemplary embodiment of the invention. Generally speaking, system 100 may constitute a host or server computer system, workstation, PDA, mobile telephone, handheld device, and the like, as desired. System 100 includes one or more processors 106, one or more buses or communication media 103, video/graphics hardware 109, storage subsystem 118, memory 121, input/output (I/0) 112, peripherals 115, communication apparatus 125, and Bluetooth subsystem or block 128.

Bus 103 provides a mechanism for the various components of system 100 to communication and couple with one another and thus acts as the backbone of the system. Processor 106, video/graphics 109, storage subsystem 118, memory 121, I/O 112, communication apparatus 125, and peripherals 115,have the structure, and perform the functions, familiar to persons of ordinary skill in the art who have the benefit of the description of the invention.

System 100 also includes Bluetooth subsystem or block 128. Bluetooth subsystem 128 provides a mechanism for communicating with Bluetooth devices (not shown explicitly), for example, Bluetooth peripherals, Bluetooth I/O devices, and the like. More specific examples include mice, joysticks, game controllers, touch pads, keyboards, keypads, presenter controls, trackballs, speakers, headsets, headphones, audio devices, printers, barcode readers, remote controllers, cameras, webcams, external Bluetooth-connected GPS receivers, etc.

Subsystem 128 also allows system 100 to set up or configure the Bluetooth devices. Generally speaking, subsystem 128 provides system 100 with the capability of providing connectivity between system 100 and the Bluetooth devices.

Generally speaking (and without limiting the utility or applicability of the invention), the disclosed inventive concepts are particularly useful for Bluetooth devices that do not offer a rich-man-machine interface, such as mice, printers, etc. Note that, rather than using the Bluetooth protocol, subsystem 128 may use other protocols, as desired, and as persons of ordinary skill in the art who have the benefit of the description of the invention understand. Some example include ultra-wideband (UWB) or IEEE 802.15 devices (including MBOA, DS (IEEE 802.15.3a), wireless universal serial bus (USB) devices, and near-field communication (NFC) or smart-card technologies (such as ISO 14443A/B), as desired. Other examples may include ZigBee and IEEE 802.15.4, as desired.

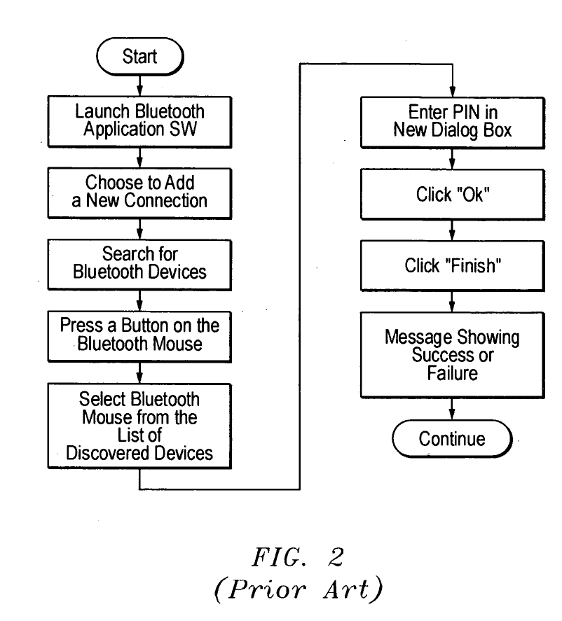

FIG. 2 illustrates a conventional method of setting up Bluetooth devices. The method starts by launching the Bluetooth application software or Bluetooth manager utility. The Bluetooth application software provides the user with the option of adding a new Bluetooth connection.

Once the user chooses to add the new Bluetooth connection, the software performs a search or service discovery for Bluetooth devices. When it finds a Bluetooth device, it begins the process of setting up a communication link to the Bluetooth device.

More specifically, the software asks the user to press a button on the Bluetooth device, a mouse, in the method shown in FIG. 2. Subsequently, the software presents the user with a list of the Bluetooth devices it detected during the search. The software then asks the user to select the Bluetooth mouse from the list of detected devices.

The software subsequently asks the user to enter a personal identification number (PIN), and click “OK.” Once the user has done so, the user then clicks “Finish.” The software then presents a message to the user indicating success of failure of setting up the communication link with the desired device (mouse).

As the flowchart in FIG. 2 shows, the conventional method of setting up a communication link with a Bluetooth device includes a relatively large number of steps. The resulting complexity may confuse or frustrate the user, or become time-consuming.

Furthermore, the relative complexity of the process tends to reduce the probability of success, and failures may result from performing the steps out-of-sequence (because of the relatively high complexity). As a consequence, the number of calls to support centers may go up, with a corresponding increase in costs for the provider of the Bluetooth solution, the computer or device vendor, or both. Additionally, increased costs associated with product returns or exchanges may result.

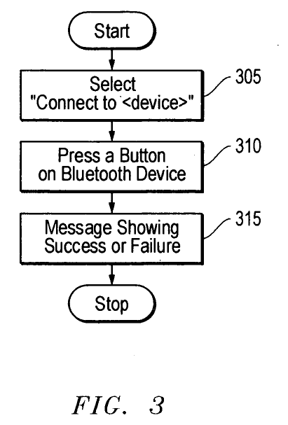

In contrast, the inventive concepts provide a simplified mechanism for setting up communication with a desired device. FIG. 3 depicts a simplified block diagram of a method for communicating with, and setting up, Bluetooth devices. The method shown in FIG. 3 provides a mechanism for the discovery, association, and pairing processes for providing connectivity with Bluetooth devices. As a result, the user has a more productive experience and is less likely to seek support. The method in FIG. 3 also helps the Bluetooth device(s) to work with system 100 out-of-box. Consequently, the overall costs to the system or device provider tend to decrease.

As a comparison of FIGS. 2 and 3 shows, the disclosed inventive method (FIG. 3) involves fewer operations than the conventional approach (FIG. 2). More specifically, the method in FIG. 3 asks the user to click on a user interface button once to establish the communication link. Note that the button may be a physical button or a soft/logical button, as desired. The user receives useful status information without having to navigate through relatively complex and numerous parts of a software application.

In addition, the disclosed solution does not entail entering a PIN. Rather, the disclosed solution uses a PIN (typically used with other inputs to generate a unique device pair link key for security purposes, as desired) or other information or parameters or variables known a priori, and pre-configured, pre-filled, or pre-populated, and stored within system 100, as desired. Examples include device type, address mask, default PINs, serial or model numbers or sequences, service capabilities, firmware version information, etc. Moreover, the proposed solution does not use pre-pairing at the factory, thus reducing the overall complexity and the cost of goods sold (COGS).

The method in FIG. 3 starts at 305, where the user selects an element of the user interface to connect to the desired device (e.g., Bluetooth mouse). The user interface element may constitute an icon in the system tray, shortcut on the GUI desktop (or elsewhere), or other desired or suitable element, as persons of ordinary skill in the art who have the benefit of the description of the invention understand.

At 310, the method asks the user to press a button on the Bluetooth device, for example, a button on a Bluetooth mouse. Doing so makes the Bluetooth device temporarily visible to other Bluetooth devices (and to system 100). In other words, the Bluetooth device transmits information that makes it visible to other devices or provides information about its characteristics.

Using the pre-configured, pre-filled, or pre-populated information (e.g., PIN or other communication parameters and variables about the selected or desired device), at 315 the method presents a status message to the user. The status message indicates whether the result of the operation, such as success or failure.

Note that if only one Bluetooth device is found, the process may be made automatic, as desired. More specifically, in such a situation, the technique described may skip seeking and obtaining user input, and may automatically connect to the discovered device.

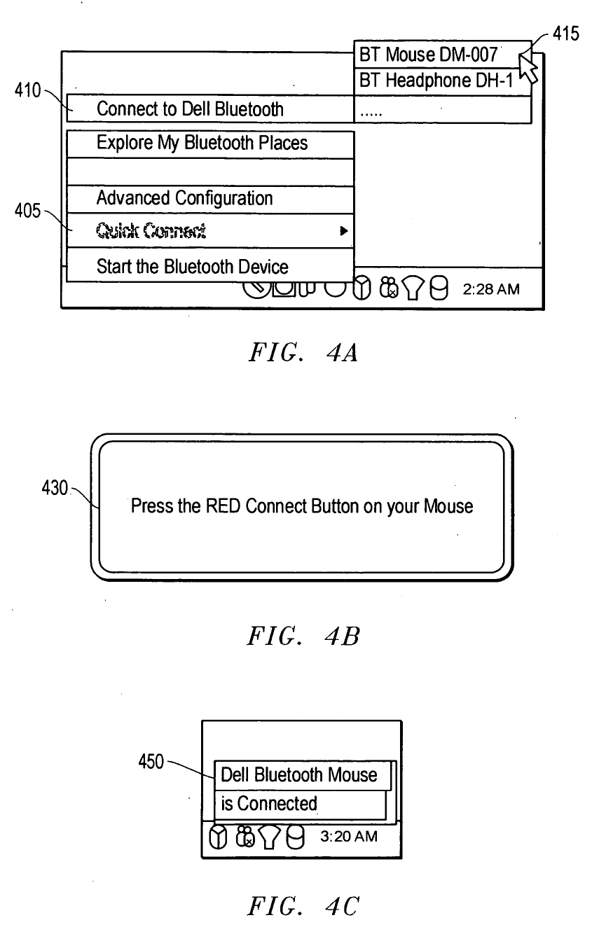

FIGS. 4A-4C show an exemplary graphical user interface (GUI) for setting up, and communicating with, a Bluetooth mouse. Note that FIGS. 4A-4C show an example of establishing communication with a Bluetooth mouse. Without limiting the general scope of the inventive concepts, the example in FIGS. 4A-4C pertain to a model DM-007 Bluetooth mouse.

As persons of ordinary skill in the art who have the benefit of the description of the invention understand, one may modify the GUI in FIGS. 4A-4C to provide communication with other types of Bluetooth devices, as desired. The details of such modifications depend on the desired device and design and performance specifications for a given application and fall within the knowledge and skill of persons of ordinary skill in the art who have the benefit of the description of the invention.

Referring to FIG. 4A, the user invokes user interface element 405 (e.g., a menu) in order to establish communication with the Bluetooth device. More specifically, the user selects item 410, “Connect to Dell Bluetooth” device. The GUI presents the user with a list of devices. From the list, the user selects “BT Mouse DM-007” to establish communication with that device.

As noted above, to establish communication with the user, the disclosed method requests that the user make the Bluetooth device visible (corresponding to 310 in FIG. 3). FIG. 4B shows an exemplary GUI element 430 presented to the user. Element 430 presents a box or other appropriate or desired item to the user. Element 430 includes an appropriate message, such as “Press the RED Connect Button on your Mouse.”

Once the user presses the appropriate button, the Bluetooth device becomes visible to other Bluetooth devices and to system 100. Using a priori known information, the method establishes communication with the desired Bluetooth device.

In FIG. 4C, the method informs the user of the result of that operation (corresponding to 315 in FIG. 3). More particularly, the method presents GUI element 450 to the user. Element 450 includes an appropriate message, such as “Dell Bluetooth mouse is Connected.”

Note that FIGS. 4A-4C show exemplary GUI implementations. As persons of ordinary skill in the art who have the benefit of the description of the invention understand, however, one may use other types or structures of GUI that may have different look-and-feel or use different or alternative elements or items, as desired.

As an optional feature, the inventive concepts contemplate a hot-key or other hardware-based triggering mechanism for establishing communication with the desired device. For example, by using the hot-key, defined or assigned function key, or other triggering mechanism, the user may invoke the described method (see FIGS. 3 and 4A-4C) in order to establish communication with a desired Bluetooth device.

Referring to the figures, persons of ordinary skill in the art will note that the various blocks shown may depict mainly the conceptual functions and signal flow. The actual circuit implementation may or may not contain separately identifiable hardware for the various functional blocks and may or may not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation, as persons of ordinary skill in the art who have the benefit of the description of the invention understand. Other modifications and alternative embodiments of the invention in addition to those described here will be apparent to persons of ordinary skill in the art who have the benefit of the description of the invention. Accordingly, this description teaches those skilled in the art the manner of carrying out the invention and are to be construed as illustrative only.

The forms of the invention shown and described should be taken as the presently preferred or illustrative embodiments. Persons skilled in the art may make various changes in the shape, size and arrangement of parts without departing from the scope of the invention described in this document. For example, persons skilled in the art may substitute equivalent elements for the elements illustrated and described here. Moreover, persons skilled in the art who have the benefit of this description of the invention may use certain features of the invention independently of the use of other features, without departing from the scope of the invention.

1. An information handling system, comprising a wireless subsystem configured to communicate with a desired wireless device, wherein the wireless subsystem uses pre-configured information about the wireless device in order to establish communication with the wireless device without an end user providing the information about the wireless device.

2. The information handling system according to claim 1, wherein the wireless subsystem comprises a Bluetooth subsystem.

3. The information handling system according to claim 2, wherein the wireless device comprises a Bluetooth device.

4. The information handling system according to claim 1, wherein the pre-configured information comprises information about a Bluetooth device.

5. The information handling system according to claim 1, wherein the wireless subsystem comprises an ultra-wideband subsystem.

6. The information handling system according to claim 5, wherein the wireless device comprises an ultra-wideband device.

7. The information handling system according to claim 1, wherein the pre-configured information comprises information about an ultra-wideband device.

8. A computer system, comprising:
an information handling apparatus, comprising:
a Bluetooth device; and
a Bluetooth subsystem configured to communicate with the Bluetooth device,
wherein the Bluetooth subsystem communicates with the Bluetooth device by using pre-configured information about the Bluetooth device stored within the information handling apparatus.

9. The computer system according to claim 8, wherein a user invokes a first element of a graphical user interface (GUI) to cause the Bluetooth subsystem to establish communication with the Bluetooth device.

10. The computer system according to claim 9, wherein the information handling apparatus uses a second element of the GUI to request the user to cause the Bluetooth device to become visible to the information handling apparatus.

11. The system according to claim 10, wherein the information handling apparatus uses a third element of the GUI to inform the user whether communication has been established with the Bluetooth device.

12. The computer system according to claim 8, wherein the Bluetooth device comprises a mouse.

13. The computer system according to claim 8, wherein the Bluetooth device comprises a headset.

14. The computer system according to claim 8, wherein the Bluetooth device comprises a peripheral device.

15. A method of communicating with a Bluetooth device, the method comprising:
obtaining a name of the Bluetooth device;
requesting a user to cause the Bluetooth device to transmit information about the Bluetooth device; and
using pre-configured information about the Bluetooth device and information transmitted by the Bluetooth device to establish communication with the Bluetooth device without obtaining information about the Bluetooth device from the user.

16. The method according to claim 15, wherein obtaining the name of the Bluetooth device further comprises obtaining a name selected by the user.

17. The method according to claim 15, wherein requesting the user to cause the Bluetooth device to transmit information about the Bluetooth device further comprises requesting the user to press a button on the Bluetooth device.

18. The method according to claim 15, wherein a hot-key is used to establish communication with the Bluetooth device.

19. The method according to claim 15, further comprising providing information about whether communication with the Bluetooth device has been established.

20. The method according to claim 15, wherein the Bluetooth device comprises a mouse.
